(19) United States
(12) Patent Application Publication
(10) Pub. No.: US 2004/0114145 A1
(43) Pub. Date: Jun. 17, 2004

(54) Dispersion compensating biosensor

(76) Inventor: Carsten Thirstrup, Charlottenlund (DK)

Correspondence Address: HARNESS, DICKEY & PIERCE, P.L.C., P.O. BOX 8910, RESTON, VA, 20195, US

(21) Appl. No.: 10/714,663

(22) Filed: Nov. 18, 2003

Related U.S. Application Data
(60) Provisional application No. 60/426,790, filed on Nov. 18, 2002.

(51) Int. Cl. G01N 21/55

(52) U.S. Cl. 356/445

(57) ABSTRACT

The present invention relates to a biosensor, comprising a transparent sensor chip, and a sensing area for interaction between provided electromagnetic radiation and a substance. The interaction between the provided electromagnetic radiation and the substance defines at least part of a response of the biosensor. The biosensor further comprises a dispersion compensating element for compensation of dispersion induced by other parts of the biosensor so that the response of the biosensor becomes essentially independent of the wavelength of the provided electromagnetic radiation interacting with the substance. The dispersion compensating element provides the compensation at least substantially independently of the effective refractive index of the substance within a predetermined effective refractive index range. The present invention further relates to a method of making the dispersion compensating elements an integrated part of the biosensor.

### FIELD OF INVENTION

The present invention relates to compensation for dispersion of light in optical based biosensors including surface plasmon resonance (SPR) sensors and resonant mirror (RM) sensors, where there is a need in the art to reduce the dispersion in order to achieve larger biosensor sensitivity. The application areas of the biosensors are within monitoring bio-/chemical bindings and detection of biological components including proteins and DNA/RNA.

### BACKGROUND OF THE INVENTION

It is well-known from the field of optics that dispersion often limits the performance in optical communication systems, since optical pulses travelling in optical fibres broadens and may eventually overlap. Many methods have been suggested of compensating for dispersion in optical communication systems (see e.g. U.S. Pat. No. 3,832,030, U.S. Pat. No. 4,655,547 and EP 1 229 676 A2).

The dispersion problem in an optical communication system is usually a matter of making compensation for the chromatic dispersion implying that two modes of light or rays of light each with a different wavelength are to be matched spatially and/or timely in the detector system. Another application area where chromatic dispersion is an issue, is solar energy concentrators, where efficient coupling of light for a broad spectrum of wavelengths is needed. In EP 0 359 179, a Fresnel-type pattern of microscopic facets has been introduced on a lens in order to compensate the dispersion of the lens. According to this reference, rays of different wavelengths which in a normal lens would be focussed at different points are focussed to essentially the same point improving the performance of the system.

The dispersion compensation for a biosensor system is different. The response of the biosensor detected by a detector system needs to be compensated for wavelength changes, but it is not simply a matter of matching the light rays spatially and/or timely on the detector system, because the bio-/chemical interactions in the biosensor induces changes of the effective refractive index and/or other optical parameters in the sensing area interacting with the light, and the dispersion compensation needs to be effective within the dynamic range of the biosensor response, i.e. the dynamic range of the effective refractive index of the sensing area. Simply correcting the chromatic dispersion for each light ray, e.g. by means of a Fresnel-type pattern, therefore does not provide a complete compensation of the biosensor system.

In surface plasmon resonance (SPR) or resonant mirror (RM) biosensors, there are two main methods of measurements known in the art. In the first method, the incident light beam is polychromatic, the angle of incidence is fixed and kept constant, and the wavelength spectrum is monitored as function of biosensor response. In the second method, the incident light beam is monochromatic or it has a narrow spectral bandwidth, and by focussing or diverging the light beam into a cone of angles, the biosensor response is monitored as function of angle of incidence. Since the refractive indices of the substrate material, the resonant mirror/surface plasmon resonance film and the biosensor element depend on wavelength, any fluctuations in the wavelength spectrum of the light source cause a change in the biosensor response that cannot be distinguished from the bio-/chemical response [N.J. Goddard et al., Sensors and Actuators A100 (2002), p.1]. Thus, any fluctuation in wavelength causes noise or drift in the biosensor signal as detected by a detector system.

Another, but in practice usually a less significant effect of dispersion is that the biosensor response gets broadened with increasing bandwidth of the light source [J. Meléndez, R. Carr, D. Bartholomew, H. Taneja, S. Yee, C. Jung, and C. Furlong, Sens. Actuators B38-39 (1997), p. 375]. Broadening causes a less well-defined biosensor signal and a poorer signal to noise ratio.

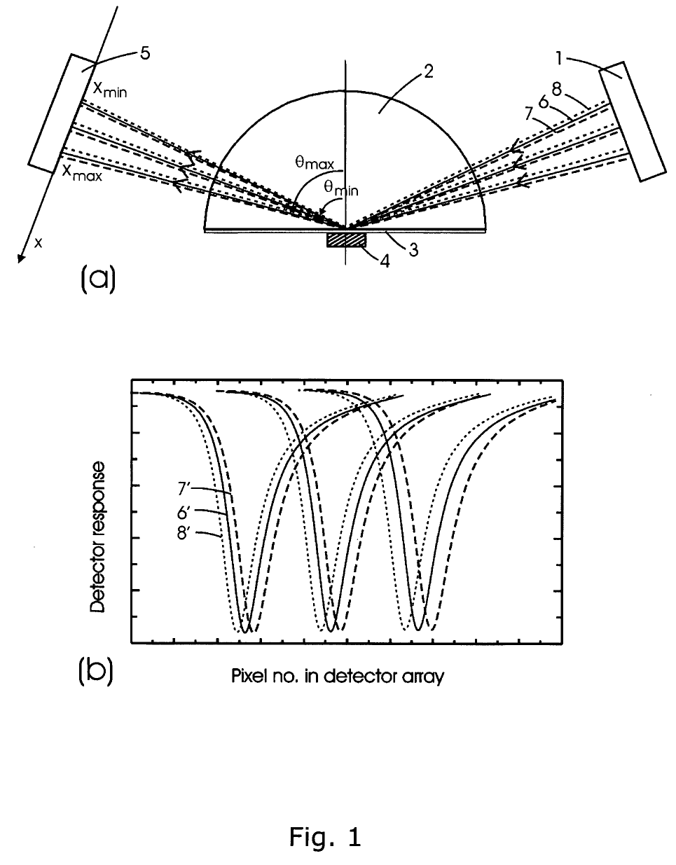

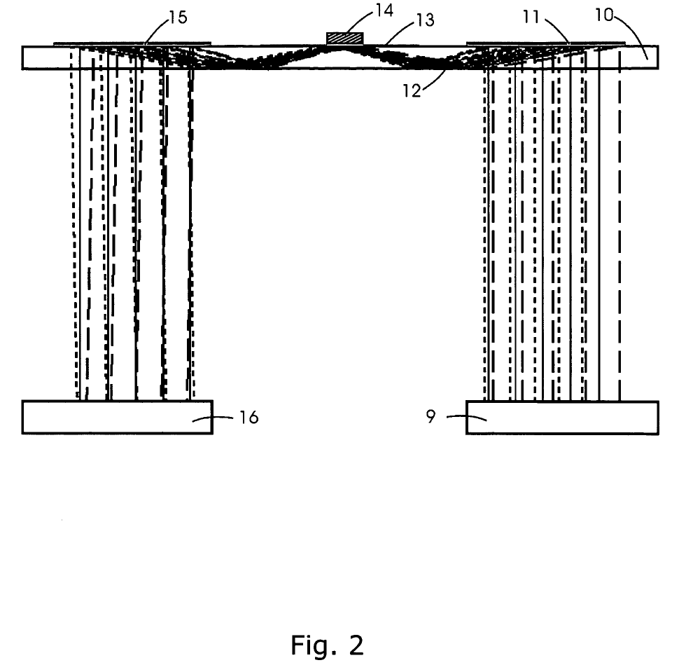

FIG. 1 and FIG. 2 are schematic illustrations of two prior art biosensor configurations, where the biosensor response is monitored as function of angle of incidence. FIG. 1(a) illustrates a prior art surface plasmon resonance (SPR) sensor based on the Kretschmann configuration [C. Nylander, B. Liedberg, and Tommy Lind, Sensors and Actuators, 3, p.79 (1982/1983); K. Matsubara, S. Kawata, and S. Minami, Applied Spectroscopy, 42, p.1375 (1988)] and with FIG. 1(b) illustrating the corresponding surface plasmon resonance responses. The sensor comprises a light source system (1) including the light source having a narrow spectral bandwidth, and a lens system focussing the light into a cone of angles, a high refractive index prism (2), a sensing area comprising a metal film (3) and a bio-/chemical sensor element (4); and a detector system (5) including a detector array and optionally defocusing optics.

In FIG. 1(a), three sets of light rays are depicted corresponding to three different effective refractive indices (nₛ) of the bio-/chemical sensor element (4), with the surface plasmon angles lying in the range from θₘᵢₙ to θₘₐₓ, Each set of rays are illustrated with three rays at different-wavelengths, a centre wavelength λ₀ [solid line (6)], a shorter wavelength λ₀-Δλ [dashed line (7)], and a longer wavelength λ₀+Δλ [dotted line (8)]. The corresponding SPR response curves are illustrated schematically in (b) with the minimum position corresponding to each ray in (a). Corresponding to the rays (6), (7) and (8), the curves are marked (6′), (7′) and (8′), respectively.

FIG. 2 is a schematic illustration of a prior art SPR sensor chip with diffractive optical coupling elements (see e.g. WO 00/46589 and WO 02/08800). With this sensor chip configuration, dispersion compensation cannot be made over the full dynamic range of the biosensor response.

Ray tracing calculations are plotted in FIG. 2 with five sets of light rays being depicted corresponding to five different effective refractive indices (nₛ) and with the surface plasmon angle lying in the range from 670 to 750. Each set comprising three rays are plotted for the same bio-/chemical response (nₛ) and having angles of incidence onto the bio-/chemical sensor element (14) corresponding to SPR minima at three different wavelengths, a centre wavelength λ₀=670 nm [solid line], a shorter wavelength λ₀−2.5 nm [dashed line], and a longer wavelength λ₀+2.5 nm [dotted line].

In the prior art non-dispersion compensated sensor chip (FIG. 2), each of the three rays corresponding to three different wavelengths is imaged onto the detector array at a separate position. As a result, the dispersion causes the three corresponding SPR response curves to be displaced relative to each other, similar to the situation as shown in FIG. 1(b). A method of fabrication of the prior art sensor chip has been described in WO 02/08800.

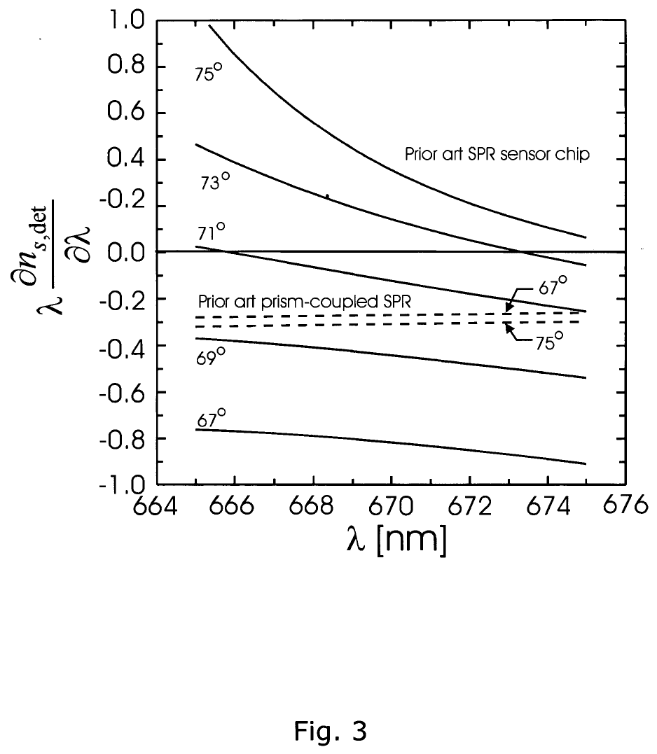

In FIG. 3, calculations of the dispersion in a prior art prism coupled SPR sensor (dashed curves) [see FIG. 1], and in a prior art non-dispersion minimised SPR sensor chip (solid curves) [see FIG. 2] are presented at five different SPR angles from 67° to 75° as indicated and for the wavelength range of ±5 nm at 670 nm. The dispersion for the prism-coupler SPR is very similar for the whole angular range and approximately ˜−0.3. The magnitude of the dispersion is similar for the non-dispersion minimised SPR chip in the angular range from ˜69° to 73° and it is somewhat larger at lower angles and at larger angles.

The traditional method of limiting the effect of wavelength dispersion in the types of biosensors as described above has been to stabilise the output wavelength spectrum of the light source. In the case of a laser diode, this can be achieved by stabilising the temperature of the laser diode housing and operate at regions, where the laser diode do not mode hop (usually an emitting wavelength abrupt change of the order of 0.3 nm at visible wavelengths). For measurements at low detection limits, there are strict requirements to the temperature stabilisation. An alternative method is combining use of a light emitting diode with a narrow bandwidth filter (typically a few nanometers full-width-half-maximum). The bandwidth filters usually have a low temperature coefficient (<0.03 nm/° C.), but the light source spectral distribution changes as function of temperature with a temperature coefficient ˜0.3 nm/° C. With changing temperature, the wavelength distribution within the filter bandwidth changes and also affects the signal to noise ratio of the biosensor system.

Accurate measurements with an SPR sensor or an RM sensor, require measurements of refractive index changes (Δnₛ) of the order of 10⁻⁶ or better. As plotted in FIG. 3, a typical prior art SPR sensor has a dispersion coefficient

$$( λ \frac{ⅆ {n}_{s}}{ⅆ λ} )$$

with a magnitude of

˜0.3 with λ being the wavelength of light and nₛ being the refractive index of the sensor element. For a visible wavelength of 670 nm, this number requires a wavelength stability (Δλ) better than 0.002 nm corresponding to a temperature stabilisation of a laser diode better than 10 mK. Reducing the dispersion in the biosensor system puts less strict requirements on the temperature stabilisation of the light source, or alternatively pushes the bio/-chemical detection limits towards lower values. There is therefore a need in the art of reducing the sensitivity of the biosensors to wavelength fluctuations.

It is an object of the present invention to reduce the sensitivity of optically based biosensors to wavelength dispersion and thereby lowering the detection limits of the biosensors.

It is a further object of the present invention to compensate the dispersion from dispersive elements in the biosensor for a desirable range of the effective refractive index of biosensor elements disposed on a sensing area as defined by bio-/chemical interactions with a substance.

It is an even further object of the present invention to make use of integrated dispersion compensating elements in a biosensor chip that compensate the dispersion from other dispersive elements on the biosensor, and thereby enable tailored optimisation of the dispersion compensation for a particular set of biosensor elements and for a desirable range of the effective refractive index of the set of biosensor elements combined with the surrounding medium.

It is a still further object of the present invention to provide a method of fabrication of the dispersion compensating elements.

### SUMMARY OF THE INVENTION

According to a first aspect of the present invention the above and other objects are fulfilled by providing a biosensor comprising

a transparent sensor chip,

a sensing area for interaction between a provided multitude of light rays with a range of angles of incidence to said sensing area and a substance, the interaction between the provided multitude of light rays and the substance defining at least part of a response of the biosensor, and

a part of the biosensor comprising at least one dispersion compensating element being adapted to, at least substantially independently of the effective refractive index of said substance within a predetermined effective refractive index range, compensate the dispersion induced in the biosensor by other parts of the biosensor,

so as to obtain a response of the biosensor being essentially independent of the wavelength of the multitude of light rays interacting with the substance.

In the present context the term ‘light rays’ should be interpreted broadly. Thus, ‘light rays’ should cover various kinds of electromagnetic radiation and covering a broad portion of the electromagnetic spectrum, including visible light, infrared light, near infrared light, ultraviolet light, and even electromagnetic radiation having a wavelength which is even longer or shorter than the wavelengths of the examples mentioned above. The choice of wavelength will depend entirely on what purpose the biosensor serves in the individual case.

The response of the biosensor is to be understood as the complete output from the entire system. This complete output may comprise a number of different components or parts, typically originating from different parts of the biosensor. Thus, one part of the response of the biosensor originates from the interaction between the provided multitude of light rays and the substance. Other parts of the response of the biosensor may originate from various optical components, a biosensor/air interface, components in a detector device, a light source providing the light rays, etc. The combination of all of these contributions will result in a response of the biosensor which is detectable.

The various components of the biosensor may each induce dispersion in the response of the biosensor. However, by introducing at least one dispersion compensating element in the biosensor, these effects may be removed, or at least considerably reduced. Thereby the detectable response of the biosensor will become essentially independent of the wavelength of the multitude of light rays interacting with the substance. The dispersion compensating element of the biosensor according to the present invention is adapted to compensate the dispersion induced in the biosensor, at least substantially independent of the effective refractive index of the substance. This means that, within a predetermined (broad) effective refractive index range of the substance, the dispersion compensating element will ensure that dispersion effects as described above are removed (or substantially reduced) from the detectable response of the biosensor. Thus, regardless of the substance applied having either a weak wavelength dependence or a known wavelength dependence of the refractive index, and regardless of possible changes in the refractive index of the substance (e.g. due to a reaction between the substance and a sample), the detectable response of the biosensor is at least substantially free from dispersion effects induced in the biosensor.

In one embodiment of the present invention, the biosensor may define an image plane, wherein the multitude of light rays are imaged onto the image plane in such a way that for any light ray rᵢ belonging to the multitude of light rays having a wavelength λᵢ and angle of incidence θᵢ, said light ray rᵢ exhibiting subpart Rᵢ of the response of the biosensor and being imaged onto the image plane at a position Pᵢ, the dispersion compensating element is adapted to ensure that any light ray rₖ belonging to the multitude of light rays having a wavelength λₖ and an angle of incidence θₖ, said light ray rₖ exhibiting a subpart of the response of the biosensor corresponding to Rᵢ is imaged onto the image plane at essentially the same position Pᵢ.

In case the biosensor is a surface plasmon resonance (SPR) sensor, a subpart of the response of the biosensor exhibited by a light ray may be a specific part of the SPR curve, such as the minimum of that curve. In this case the response of the biosensor according to the present invention ensures, due to the dispersion compensating element, that such parts of the response, originating from corresponding parts of the SPR curve, are imaged onto essentially the same point on the image plane.

The biosensor may further comprise a detector array. In case the biosensor defines an image plane, the detector array may advantageously be positioned in the image plane.

The biosensor may further be adapted to yield minimum dispersion of the response of the biosensor by adjusting the distance between the transparent sensor chip and the detector array. Alternatively or additionally, it may be adapted to yield minimum dispersion of the response of the biosensor by adjusting an angle between a direction defined by a mean propagation vector of the incoming light rays and a plane defined by the detector array.

As mentioned above, the response of the biosensor may preferably be a surface plasmon resonance response, and the biosensor may preferably be a surface plasmon resonance sensor.

The transparent sensor chip is preferably solid, i.e. it is manufactured in one piece, e.g. from a glass material or from another suitable material being transparent to the wavelengths being applied to the biosensor.

The other parts of the biosensor may comprise one or more conducting films being arranged on an exterior surface part of the transparent sensor chip, and forming part of the sensing area. The one or more conducting films may be arranged in a multilayer system of conducting films, and they may comprise metal layers of a material selected from the group consisting of aluminium, gold, silver or the like. Thus, the one or more conducting films are preferably suitable for supporting surface plasmons.

Alternatively or additionally, the other parts of the biosensor may comprise a multilayer of dielectric materials forming a resonant mirror being arranged on an exterior surface part of the transparent sensor chip, and forming part of the sensing area.

In one embodiment the biosensor further comprises a first and a second diffractive optical element forming part of a surface of the transparent sensor chip, the diffractive optical elements each comprising a grating structure. Preferably, one of the diffractive optical elements is adapted for coupling the multitude of light rays into the biosensor, and the other diffractive optical element is adapted for coupling the multitude of light rays out of the biosensor after the multitude of light rays have interacted with the substance.

At least one of the dispersion compensating element(s) may form part of at least one of the diffractive optical elements. Thus, at least one of the diffractive optical elements may be constructed in such a way that it is capable of providing a dispersion compensating effect. Furthermore, the dispersion compensating element(s) forming part of at least one of the diffractive optical elements may be adapted to compensate the dispersion induced by said diffractive optical element.

The grating structures may form a transmission grating structure or the grating structures may form a reflection grating structure. In one embodiment, one of the grating structures may form a transmission grating structure and the other grating structure may form a reflection grating structure.

The first diffractive optical element may be adapted to focus or diverge an incoming light ray. Furthermore, the second diffractive optical element may be adapted to collimate a diverging light ray.

The diffractive optical elements may further comprise one or more calibration marks, said one or more calibration marks being areas with missing grating structures.

Preferably, the multitude of light rays are incident at least substantially normal to a plane defined by the first diffractive optical element. The first diffractive optical element in turn directs the multitude of light rays onto the sensing area with a range of angles of incidence. Preferably, the plane defined by the first diffractive optical element is at least substantially parallel to a plane defined by the sensing area.

At least the dispersion compensating element may be provided by performing the following steps:

providing a master substrate having a substantially plane surface,

providing a photosensitive layer of material onto the substantially plane surface of the master substrate,

providing a first surface relief pattern by exposing the photosensitive layer to a first and a second wave of electromagnetic radiation so as to expose the photosensitive layer to a first interference pattern generated by a spatial overlap at an intersection between the first wave of electromagnetic radiation having a first focussed area and the second wave of electromagnetic radiation having a second focussed area,

providing a second surface relief pattern by exposing the photosensitive layer to a third and a fourth wave of electromagnetic radiation so as to expose the photosensitive layer to a second interference pattern generated by a spatial overlap at an intersection between the third wave of electromagnetic radiation having a third focussed area and the fourth wave of electromagnetic radiation having a fourth focussed area,

wherein the positions of the first, second, third, and fourth focussed areas are selected in such a way that the first and second diffractive optical elements replicated from the surface relief patterns compensate for dispersion induced by other parts of the optical sensor.

According to a second aspect of the present invention the above and other objects are fulfilled by providing a method of forming surface relief patterns adapted to be replicated onto a substantially plane surface of a member to form a first and a second diffractive optical element, the substantially plane member forming part of an optical sensor, the method comprising the steps of

providing a master substrate having a substantially plane surface,

providing a photosensitive layer of material onto the substantially plane surface of the master substrate,

providing a first surface relief pattern by exposing the photosensitive layer to a first and a second wave of electromagnetic radiation so as to expose the photosensitive layer to a first interference pattern generated by a spatial overlap at an intersection between the first wave of electromagnetic radiation having a first focussed area and the second wave of electromagnetic radiation having a second focussed area,

providing a second surface relief pattern by exposing the photosensitive layer to a third and a fourth wave of electromagnetic radiation so as to expose the photosensitive layer to a second interference pattern generated by a spatial overlap at an intersection between the third wave of electromagnetic radiation having a third focussed area and the fourth wave of electromagnetic radiation having a fourth focussed area,

wherein the positions of the first, second, third, and fourth focussed areas are selected in such a way that the first and second diffractive optical elements replicated from the surface relief patterns compensate, at least substantially independently of the effective refractive index of said substance within a predetermined effective refractive index range, for dispersion induced by other parts of the optical sensor.

Thus, the surface relief patterns provided by this method provide diffractive optical elements which are also adapted to compensate for dispersion induced by other parts of the optical sensor. Once formed, the dispersion compensating elements function in the way described above.

In the present context the term ‘focussed area’ should be interpreted as an area of the photosensitive layer onto which the corresponding light beam is focussed. It should also be interpreted as covering an actual continuous area of the photosensitive layer, as well as a number of points, e.g. being arranged in an array, or lines.

The master substrate may be rotated approximately 180 degrees after the providing of the first surface relief pattern and prior to the providing of the second surface relief pattern. In this case the first wave of electromagnetic radiation and the third wave of electromagnetic radiation may advantageously originate from the same light source. Similarly, the second wave of electromagnetic radiation and the fourth wave of electromagnetic radiation may originate from the same light source. Thus, in this embodiment the first surface relief pattern is first provided. The substrate is then rotated approximately 180 degrees. Finally, the second surface relief pattern is provided using the same two light sources. Thereby the first and the second surface relief patterns are substantially identical, but one is rotated approximately 180 degrees as compared to the other.

The first, second, third and fourth waves of electromagnetic radiation may have substantially the same wavelength, and the first, second, third and fourth waves of electromagnetic radiation may originate from the same light source. The same light source may comprise a laser, such as a HeCd laser, a Kr-laser, an excimer laser, or a semiconductor laser.

The method may further comprise the step of developing the photosensitive layer, thereby providing the first and second diffractive optical elements.

The first wave of electromagnetic radiation may form an object wave, and the second wave of electromagnetic radiation may form a reference wave.

The master substrate may be constituted by a substantially transparent member, such as a glass member or a polymer member, or a member made from another suitable material with desired transparency properties. The polymer member may be made of acrylics, polycarbonate, polystyrene, polyetherimide (trade name ULTEM),a polyurethane resin, or cyclo-olefin-copolymers (trade name TOPAS).

The method may further comprise the step of performing a sacrificial-layer-etch of the photosensitive layer in order to replicate the first and second surface relief patterns into the substantially plane surface of a substantially transparent member. The step of performing a sacrificial-layer-etch of the photosensitive layer may be achieved by means of ion-milling, chemically assisted ion-beam etching or reactive ion etching, or by means of any other suitable method.

The method may further comprise the step of forming a negative metal master of the first and second surface relief patterns for further replication of said first and second surface relief patterns. The metal master may be a nickel master. Alternatively, the metal master may be made from any other suitable metal or alloy.

The method may further comprise the step of replicating, in a substantially transparent sensor chip, the first and second surface relief patterns from the negative metal master using hot embossing, injection moulding, injection compression moulding or any other suitable method.

The method may further comprise the step of providing a metal layer on top of the replicated first and second surface relief patterns. The metal layer may be provided by means of thermal evaporation, e-beam evaporation or sputtering, and it may comprise a material selected from the group consisting of aluminium, gold, silver or the like.

### BRIEF DESCRIPTION OF THE INVENTION

The present invention will now be described in further details with reference to the accompanying figures, in which

FIG. 1 is a schematic illustration of a prior art surface plasmon resonance (SPR) sensor based on a Kretschmann configuration (a). Three sets of light rays are depicted corresponding to the surface plasmon angle (θ_{SPR}) lying in the range from θₘᵢₙ to θₘₐₓ, each with three rays of different wavelength, a centre wavelength λ₀ [solid line], a shorter wavelength λ₀−Δλ [dashed line], and a longer wavelength λ₀+Δλ [dotted line]. The corresponding surface plasmon resonance (SPR) response is illustrated schematically in (b) with the minimum in the SPR response curve corresponding to each ray in (a),

FIG. 2 is a schematic illustration of prior art with an SPR sensor chip without dispersion compensation. Ray tracing calculations are plotted with five sets of light rays being depicted corresponding to five different effective refractive indices (nₛ) and with the surface plasmon angle lying in the range from 67° to 75°. Each set comprising three rays are plotted for the same bio-/chemical response (nₛ) and having angles of incidence onto the bio-/chemical sensor element (4) corresponding to SPR minima at three different wavelengths, a centre wavelength λ₀=670 nm [solid line], a shorter wavelength λ₀−2.5 nm [dashed line], and a longer wavelength λ₀+2.5 nm [dotted line],

FIG. 3 shows calculations of the dispersion in prior art SPR systems with a prism-coupler SPR sensor (dashed curves) as illustrated in FIG. 1, and an SPR sensor chip as illustrated in FIG. 2 (solid curves) at five different SPR angles from 67° to 75° as indicated,

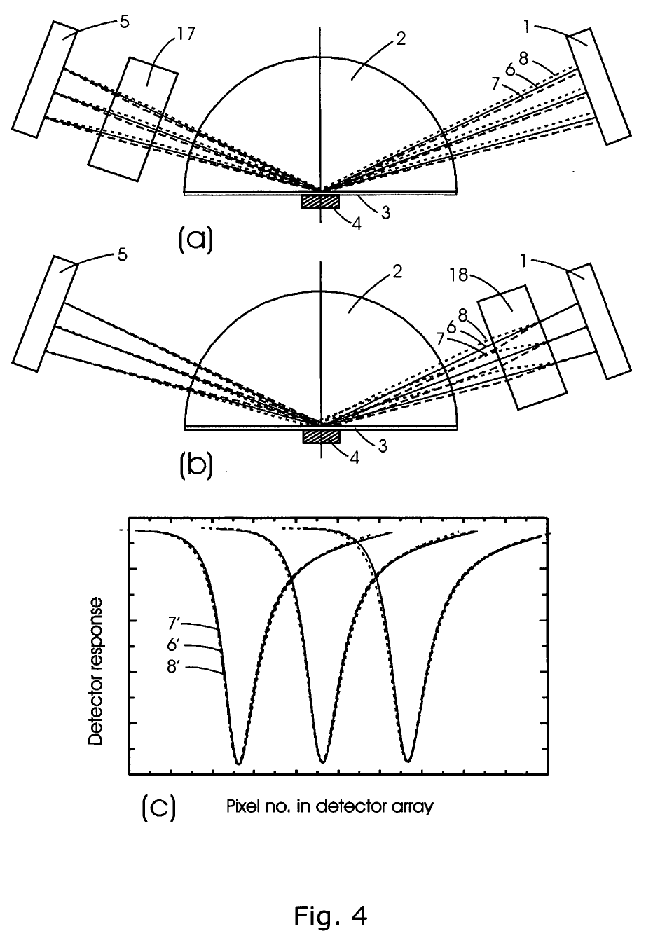

FIG. 4 is a schematic illustration of two embodiments of the present invention comprising a dispersion compensated SPR sensor based on a modified Kretschmann configuration. Three sets of light rays are depicted spanning the angular range from θₘᵢₙ to θₘₐₓ, each with three rays of different wavelength, a centre wavelength λ₀ [solid line], a shorter wavelength λ₀−Δλ [dashed line], and a longer wavelength λ₀−Δλ [dotted line]. A dispersion compensating component is positioned (a) after the sensing area and (b) before the sensing area. The corresponding surface plasmon resonance (SPR) response is illustrated schematically in (c) with the minimum in the SPR response curve corresponding to each ray in (a) and (b). The dispersion compensation implies that the SPR response is essentially wavelength independent,

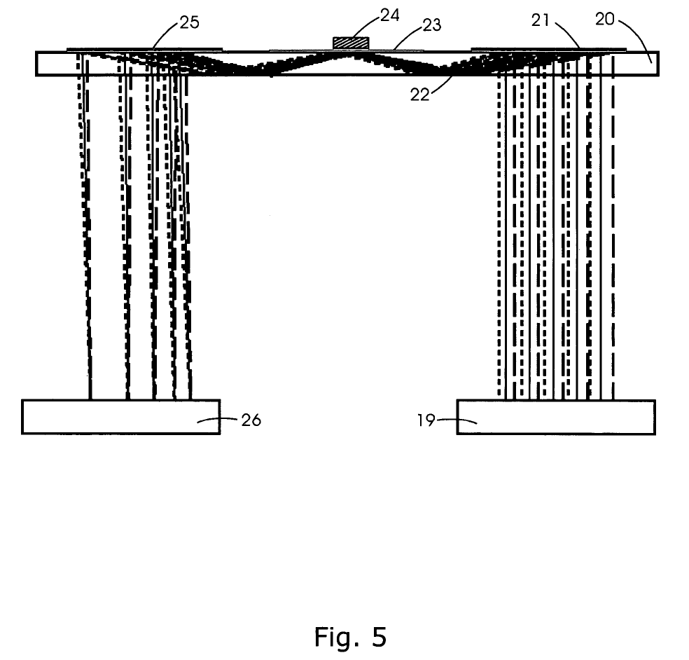

FIG. 5 is a schematic illustration of the preferred embodiment of the present invention with the SPR sensor chip comprising input coupling and output coupling reflection diffractive optical elements (RDOEs) enabling dispersion compensation. Ray tracing calculations are plotted with five sets of light rays being depicted corresponding to five different effective refractive indices (nₛ) and with the surface plasmon angle lying in the range from 67° to 75°. Each set comprising three rays are plotted for the same bio-/chemical response (nₛ) and having angles of incidence onto the bio-/chemical sensor element (24) corresponding to SPR minima at three different wavelengths, a centre wavelength λ₀=670 nm [solid line], a shorter wavelength λ₀−2.5 nm [dashed line], and a longer wavelength λ₀+2.5 nm [dotted line],

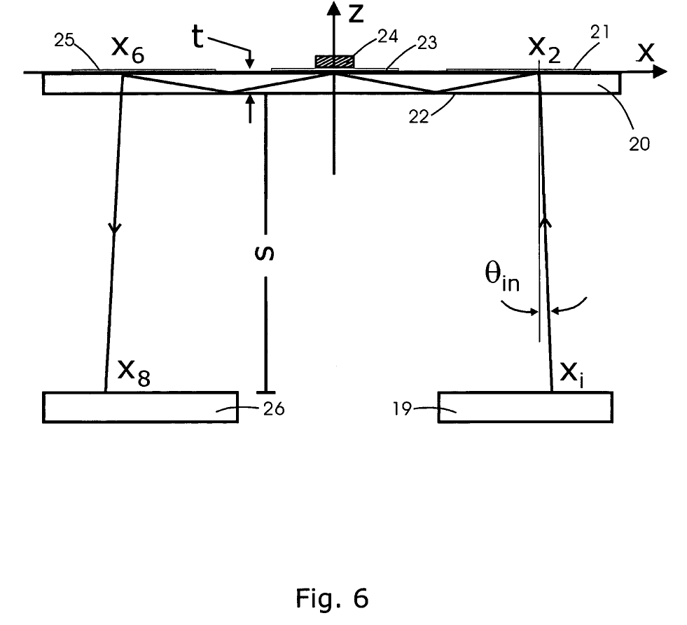

FIG. 6 is an illustration of the definition of the variables used in the mathematical description of dispersion minimisation in the preferred embodiment of the present invention. A rectangular coordinate system (x,z) is defined with the x-axis being along the grating spacing of the RDOE of the sensor chip and the z-axis being perpendicular to the planes of the sensor chip,

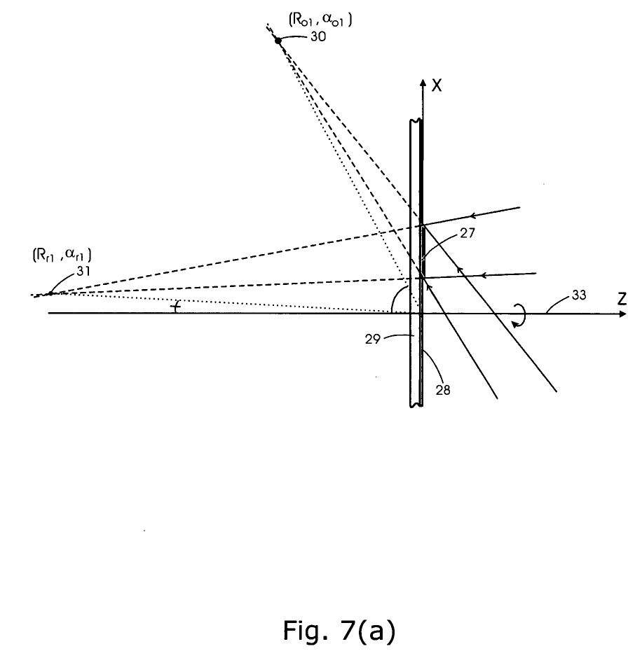

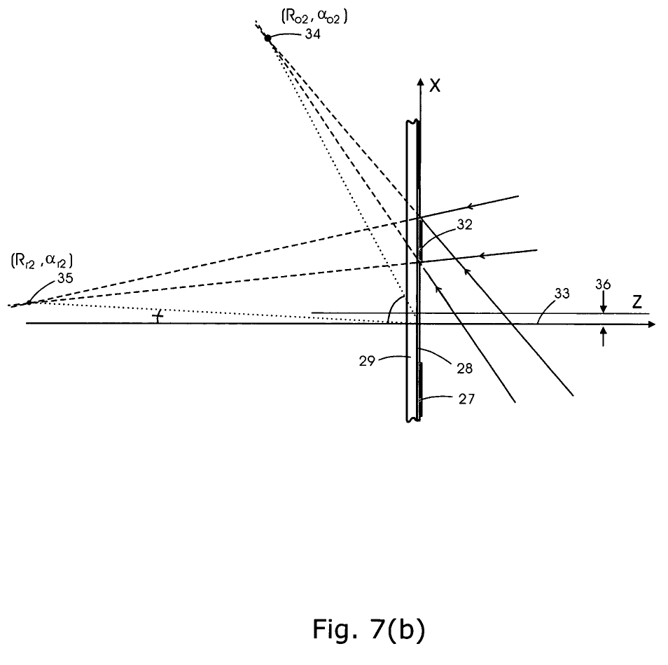

FIG. 7 is a schematic illustration of a method of forming a dispersion compensating biosensor with (a) a first surface relief pattern and (b) a second surface relief pattern adapted to be replicated in a first reflective diffractive optical element (RDOE) for input coupling and a second RDOE for output coupling, respectively. The pair of RDOEs has two functions; as optical coupling elements and dispersion compensating elements. The positions of the object waves and the reference waves for the pair of RDOEs are adjusted in order to enable minimum dispersion for the detected signal of the biosensor response,

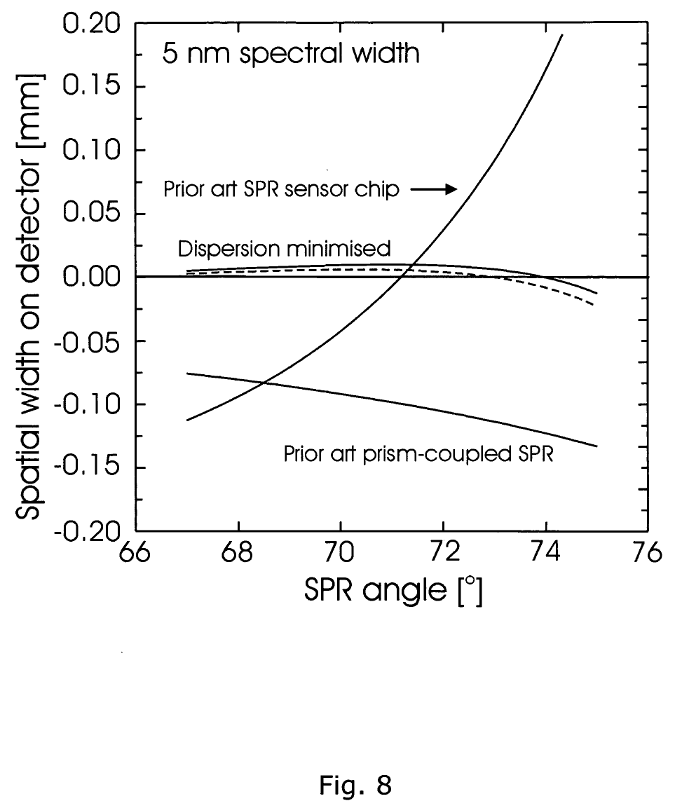

FIG. 8 shows calculations of dispersion minimisation of the spatial width of light rays on a detector array exhibiting a minimum in the SPR response for the wavelength range from λ₀−2.5 nm to λ₀+2.5 nm as function of SPR angle for λ₀=670 nm. As depicted, results are plotted for the case of a prior art prism-coupled SPR sensor (see FIG. 1), a prior art non-dispersion minimised SPR sensor chip (see FIG. 3) and a dispersion minimised SPR sensor chip, which is the preferred embodiment of the present invention (see FIG. 5). In addition, for the case of the dispersion minimised SPR sensor chip, a calculation including the dispersion of the bio-/chemical sensor element showing the same dispersion as water is illustrated as a dashed curve, and

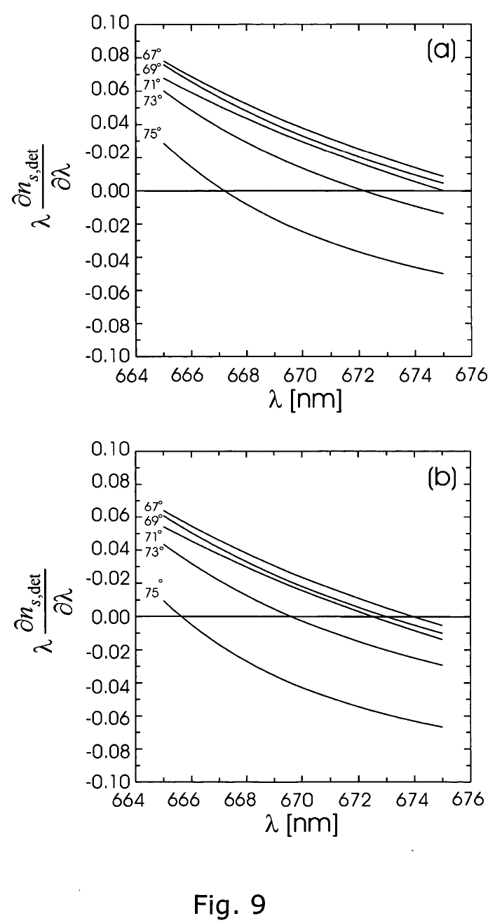

FIG. 9 shows calculations of dispersion in a dispersion minimised SPR sensor chip, which is the preferred embodiment of the present invention (see FIG. 5). In (a) a calculation is illustrated with the inclusion of dispersion of the sensor chip substrate and metal film and in (b), a similar calculation is illustrated, but additionally including the dispersion of a bio-/chemical sensor element exhibiting the same functional dependence of refractive index on wavelength as water.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In the embodiments of the present invention, the dispersion of light is compensated in order to provide wavelength independent detection of the biosensor response in optical based biosensors including surface plasmon resonance (SPR) sensors and resonant mirror (RM) sensors.

The following description is based on surface plasmon resonance (SPR) sensors, but the principles are general and the mathematics can readily be modified to cover other types of biosensors like a resonant mirror (RM) sensor. The following description additionally assumes SPR sensor configurations where the light is essentially focussed onto a line perpendicular to the plane of incidence. The mathematics can readily be modified to cover SPR sensor configurations with other symmetries including configurations where the light is essentially focussed onto one or more points.

In the present description, an approximation for the calculation of the SPR response is being used and ray tracing is being used to describe the propagation of light. However, as it is known by a person skilled in the art, the numerical model can readily be made more extensive, for example employing the Fresnel coefficients at the interface between the sensor chip substrate and the metal film and between the metal film and the superstrate (the sensing area) in the calculation of the SPR response, and replacing the approximate analytical expression between SPR angle and effective refractive index by a numerical exact calculation. Rather than using ray tracing, the light can be treated in a vector form solving Maxwells equations for the sensor chip with diffractive optical elements and metal film.

In an SPR sensor, the SPR angle (θ_{SPR}) corresponding to the minimum in the SPR response is approximately given by;

$${n}_{g} sin {θ}_{SPR} ≅ {[ \frac{{ϵ}_{m r}^{′} {n}_{s}^{2}}{{ϵ}_{m r}^{′} + {n}_{s}^{2}} ]}^{1 / 2} , \qquad ( 1 )$$

where n_{g} is the refractive index of the substrate material, ε′ₘᵣ is the real part of the complex refractive index of the metal film, and nₛ is the effective refractive index of the superstrate, i.e. the layer on the top of the metal film comprising bio-/chemical sensor elements and a medium, usually a liquid or air.

Taking the partial derivative of eqn.(1) with respect to the wavelength (λ), yields the following expression for the dispersion of the bio-/chemical sensing area;

$$λ \frac{\partial {n}_{s}}{\partial λ} = \frac{{n}_{s}^{3}}{2 {ϵ}_{m r}^{′2}} ( - λ \frac{\partial {ϵ}_{m r}^{′}}{\partial λ} ) + \frac{{n}_{s}}{{n}_{g}} ( 1 + \frac{{n}_{s}^{2}}{{ϵ}_{m r}^{′}} ) ( λ \frac{\partial {n}_{g}}{\partial λ} ) + ( \frac{\partial {n}_{s}}{\partial {θ}_{SPR}} ) ( λ \frac{\partial {θ}_{SPR}}{\partial λ} ) , \qquad ( 2 )$$

where;

$$\frac{\partial {n}_{s}}{\partial {θ}_{SPR}} = {n}_{s 0} ( 1 + \frac{{n}_{s}^{2}}{{ϵ}_{m r}^{′}} ) \sqrt{\frac{{ϵ}_{m r}^{′} ( {n}_{g}^{2} - {n}_{s}^{2} ) + {n}_{g}^{2} {n}_{s}^{2}}{{ϵ}_{m r}^{′} {n}_{s}^{2}}} . \qquad ( 3 )$$

The three dispersion terms on the right hand side of eqn. (2) originate from the metal film, the substrate material, and the angular dispersion. A detector array detects an SPR angle and converts it to an effective refractive index (n_{s,det}) In the case of a prior art Kretchmann SPR setup as illustrated schematically in FIG. 1, the following expression for the dispersion at the detector can then be obtained;

$$λ \frac{\partial {n}_{s , de t} ( λ , {n}_{s} )}{\partial λ} = λ \frac{\partial {n}_{s} ( λ , {θ}_{SPR} )}{\partial {θ}_{SPR}} \frac{\partial {θ}_{SPR} ( λ , {n}_{s} )}{\partial λ} = ( λ \frac{\partial {n}_{s}}{\partial λ} ) + \frac{{n}_{s}^{3}}{2 {ϵ}_{m r}^{′2}} ( λ \frac{\partial {ϵ}_{m r}^{′}}{\partial λ} ) - \frac{{n}_{s}}{{n}_{g}} ( 1 + \frac{{n}_{s}^{2}}{{ϵ}_{m r}^{′}} ) ( λ \frac{\partial {n}_{g}}{\partial λ} ) . \qquad ( 4 )$$

In the present invention, compensation for the effect of the dispersion is made introducing a dispersion compensating element as illustrated schematically in FIG. 4. The angle incident onto the detector is then given by θ=θ_{SPR}+θ_{compensation}, and the dispersion yields;

$$λ \frac{\partial {n}_{s , de t} ( λ , {n}_{s} )}{\partial λ} = λ \frac{\partial {n}_{s} ( λ , θ )}{\partial θ} ( \frac{\partial {θ}_{SPR} ( λ , {n}_{s} )}{\partial λ} + \frac{\partial {θ}_{compensation} ( λ , {n}_{s} )}{\partial λ} ) , \qquad ( 5 )$$

where, using eqn.(3) and (4);

$$\frac{\partial {θ}_{SPR} ( λ , {n}_{s} )}{\partial λ} = \frac{( \frac{1}{{n}_{s}} \frac{\partial {n}_{s}}{\partial λ} ) + \frac{{n}_{s}^{2}}{2 {ϵ}_{m r}^{′}} ( \frac{1}{{ϵ}_{m r}^{′}} \frac{\partial {ϵ}_{m r}^{′}}{\partial λ} ) - ( 1 + \frac{{n}_{s}^{2}}{{ϵ}_{m r}^{′}} ) ( \frac{1}{{n}_{g}} \frac{\partial {n}_{g}}{\partial λ} )}{( 1 + \frac{{n}_{s}^{2}}{{ϵ}_{m r}^{′}} ) \sqrt{\frac{{ϵ}_{m r}^{′} ( {n}_{g}^{2} - {n}_{s}^{2} ) + {n}_{g}^{2} {n}_{s}^{2}}{{ϵ}_{m r}^{′} {n}_{s}^{2}}}} . \qquad ( 6 )$$

According to eqn. (5), full dispersion compensation requires that the following equality be fulfilled in the dynamic range of nₛ required for the SPR measurements;

$$\frac{\partial {θ}_{compensation} ( λ , {n}_{s} )}{\partial λ} = - \frac{\partial {θ}_{SPR} ( λ , {n}_{s} )}{\partial λ} . \qquad ( 7 )$$

Eqn. (7) has to be satisfied for all λ in the desirable wavelength range (λₘᵢₙ,λₘₐₓ) of the light source and for all nₛ in the desirable effective refractive index range (n_{s,min},n_{s,max}) of the sensing area. This can be expressed as;

$${\int }_{{n}_{s , min}}^{{n}_{s , max}} {\int }_{{λ}_{min}}^{{λ}_{max}} {( \frac{\partial {θ}_{compensation} ( λ , {n}_{s} )}{\partial λ} + \frac{\partial {θ}_{SPR} ( λ , {n}_{s} )}{\partial λ} )}^{2} ⅆ λ ⅆ {n}_{s} = 0 , \qquad ( 8 )$$

In practice, it is normally not possible to satisfy equation (8) for all refractive indices (i.e. at all SPR angles) and all wavelengths in the desirable ranges. Alternatively, dispersion minimisation can be achieved by minimising the following expression numerically;

$${min}_{{θ}_{compensation}} \{ {\sum }_{{n}_{s } = {n}_{s , min}}^{{n}_{s , max}} {\sum }_{λ = {λ}_{min}}^{{λ}_{max}} {( \frac{\partial {θ}_{compensation} ( λ , {n}_{s} )}{\partial λ} + \frac{\partial {θ}_{SPR} ( λ , {n}_{s} )}{\partial λ} )}^{2} \} , \qquad ( 9 )$$

where θ_{compensation} is adjusted accordingly depending on the embodiment of the invention of dispersion compensated SPR sensor.

FIG. 4 is a schematic illustration of two embodiments of the present invention comprising a dispersion compensated SPR sensor based on a modified Kretschmann configuration. In addition to the components as described in the prior art in FIG. 1(a), the embodiment of the present invention in FIG. 4(a) comprises a dispersion compensating element (17) positioned after the sensing area (3) and (4). Light rays originating from a light source system (1) are coupled into a high index prism (2), focussed onto an metal film (3) underneath one or more bio-/chemical sensor elements (4), reflected from the metal film, coupled out of the prism (2), propagating through a dispersion element (17) that compensates for the dispersion of all other elements in such a manner that the biosensor response detected by the detector system (5) is essentially wavelength independent in a wavelength region from λₘᵢₙ=λ₀−Δλ to λₘₐₓ=λ₀+Δλ and for an effective refractive index range from n_{s,min} to n_{s,max}. The detector system (5) may also comprise collimating optics, glass windows, filters or the like. In that case the dispersion compensating element also needs to compensate for such dispersive elements. For a person skilled in the art, it is simple to include these elements in the design of the dispersion compensation element. The present invention also covers configurations, where the prism is divided into a coupling prism, an index matching gel or index matching oil, and a flat glass plate onto which the metal film is attached.

FIG. 4(b) shows another embodiment of the present invention, where the dispersion compensation element (18) is disposed before the sensing area of the SPR sensor. The function of the element (18) is the same as the element (17). Alternative embodiments of the present invention include two dispersion compensation elements, one being disposed before the sensing area and one after the sensing area. As illustrated schematically in FIG. 4(a) and (b), the size of the light beam underneath the sensing area (3) and (4) is normally larger when the dispersion compensation element is disposed after rather than before the sensing area. Other alternative embodiments of the present invention include two or more dispersion compensation elements being disposed before the sensing area and two or more dispersion compensation elements being disposed after the sensing area.

The dispersion compensating elements may include elements such as one or more dispersion prisms, dispersive equilateral prisms, diffractions gratings, either transmission types or reflection types, and holographics gratings. The dispersion compensating elements may be discrete components as illustrated in FIG. 4, or they may be integrated onto the surface of the prism (2). Alternatively; the prism itself may have a refractive index profile or curvatures of the prism surfaces interacting with the light being adapted to compensate the dispersion.

The wavelength compensating region ±Δλ from λ₀ is preferably in the range from ±0.02%λ₀ to ±6%λ₀, more preferably in the range from ±0.1%λ₀ to ±2%λ₀, and even more preferably in the range from ±0.5%λ₀ to ±1%λ₀.

Note that the dispersion compensation in FIGS. 4(a) and 4(b) is made in such a manner that a multitude of light rays, each with a different wavelength provide equal response on the biosensor detector system, but rays originating from the same point [e.g. 8 in FIG. 4(a) and 4(b)] will be separated spatially on the detector system. The light rays (6) with a wavelength λ₀, (7) with a wavelength λ₀−Δλ and (8) with a wavelength λ₀+Δλ having SPR minima for the same bio-/chemical response (Δnₛ) are essentially incident on the same spot on the detector system (5). FIG. 4(c) illustrates that with the dispersion compensating element, the corresponding three SPR curves essentially have the SPR response minimum at the same position. The design of the dispersion compensating element is made in such a manner that other sets of rays within the desirable wavelength range also fulfil this condition.

FIG. 5 is a schematic illustration of the preferred embodiment of the present invention, which is an SPR sensor chip with an input coupling reflection diffractive optical element (RDOE) (21) and an output coupling RDOE (25) enabling dispersion compensation. As illustrated in FIG. 5, a collimated light beam originates from a narrow bandwidth light source system (19), which may include a collimation lens or a lens system, mirrors, narrow bandwidth filters and polarization components. The light beam enters the SPR sensor chip (20) perpendicularly to the backside surface of the SPR sensor chip. Inside the SPR sensor chip, the light beam is reflected from a reflective diffractive optical element (RDOE) (21) transforming the light beam into a focusing light beam. Via a flat reflective surface (22) on the backside of the SPR sensor chip, the light beam is subsequently reflected and focused onto a line on a SPR metal film (23) underneath one or more sensor elements (24) on the top. The focused light beam comprises angular bands covering the SPR angle. After being reflected from the SPR metal film (23), the light beam is reflected from the surface (22). Via a second RDOE (25), it is transformed into a quasi-collimated light beam, which exits the SPR sensor chip essentially perpendicularly to the backside surface of the SPR sensor chip and the light beam is imaged onto the detector array (26). “Quasi-collimated” and perpendicular mean that the output angle of the rays relative to the backside surface of the SPR sensor chip are preferably less than ±15°, more preferably less than ±7°, and even more preferably less than ±3°. “Similar beam sizes” means that the difference in size is preferably less than ±30%, more preferably less than ±10%, and even more preferably less than ±3%.

The present invention also covers other embodiments with different configurations of diffractive optical elements exhibiting dispersion minimisation. Such diffractive optical elements includes RDOE exhibiting dispersion minimisation and transmission diffractive optical elements (TDOEs) exhibiting dispersion minimisation, where a first RDOE or TDOE transforms an input light beam onto essentially a point or a line under one or more sensor elements (24) and a second RDOE or TDOE transforms said light beam into an output light beam exiting the SPR sensor. The input light beams and the output light beams may be essentially collimated and perpendicular to the backside surface of the sensor chip (i.e. input angle of incidence and output angle of incidence being essentially equal to zero). Alternatively, said light beams may be diverging light beams or converging light beams having an input angle of incidence and/or an output angle of incidence being different from zero and being either negative or positive.

The input light beam may be essentially a point source such as a light emitting diode or a resonant cavity light emitting diode with or without a narrow bandwidth filter, a Fabry-Perot single mode or a multimode laser diode, or a vertical cavity surface emitting laser diode. The input light beam may alternatively be essentially a line source such as an array of resonant cavity light emitting diodes or an array of vertical cavity surface emitting laser diodes.

The present invention also covers configurations, where the distance between the output light beam being reflected from a second diffractive optical element (25) and the detector array (26) and/or the angle between the incident light beam and the plane of the detector is adjusted in order to yield minimum dispersion. The detector array may comprise a one dimensional or two dimensional CCD image sensor or CMOS image sensor, or a photodiode array.

The present invention also covers configurations of non-dispersion compensated sensor chips, where the dispersion compensating elements are externally positioned either before the input to the sensor chip, after the output of the sensor chip or at both positions. The dispersion compensating elements may include elements such as one or more dispersion prisms, dispersive equilateral prisms, diffractions gratings, either transmission types or reflection types, and holographics gratings.

Ray tracing calculations are plotted in FIG. 5 with five sets of light rays being depicted corresponding to five different effective refractive indices (nₛ) and with the surface plasmon angle lying in the range from 67° to 75° corresponding to a range in the effective refractive index (nₛ) from approximately n_{s,min}=1.33 to n_{s,max}=1.37. Each set comprising three rays are plotted for the same bio-/chemical response (i.e. same nₛ) and having angles of incidence onto the bio-/chemical sensor element (24) corresponding to SPR minima at three different wavelengths, a centre wavelength λ₀=670 nm [solid line], a shorter wavelength λ₀−2.5 nm [dashed line], and a longer wavelength λ₀+2.5 nm [dotted line].

In the embodiment of the present invention in FIG. 5, the three rays corresponding to three different wavelengths are imaged onto the detector array at essentially the same positions. As a result, the dispersion compensation causes the three corresponding SPR response curves to be matched with each other, similar to the situation as shown in FIG. 4(c). Thus, for an effective refractive index range from n_{s,min} to n_{s,max}, the biosensor response determined by the detector system (26) exhibits only a weak wavelength dependence in a wavelength region from λₘᵢₙ=λ₀−Δλ to λₘₐₓ=λ₀+Δλ. If the light source used has a central wavelength different from λ₀, the angle of incidence of input light to the sensor chip can be adjusted to compensate for the difference in wavelength and thereby ensure optimum performance of the sensor chip regarding dispersion minimisation and a centred position of the focus of the light underneath one or more sensor elements (24).

Minimisation of the dispersion as described by eqn. (7) can be achieved using ray tracing in the sensor chip and minimising the difference in the position of the rays with different wavelength on the detector. FIG. 6 illustrates the diffraction and refraction points of a ray propagating from the light source system (19) to the detector array (26). The grating equation for the input diffractive optical coupling element reads

$$sin {θ}_{o} = \frac{λ}{{n}_{g} ( λ ) {a}_{i} ( {x}_{2} )} + {θ}_{i n} , \qquad ( 10 )$$

where θᵢₙ, and θ₀ are the angle of incidence and the diffraction angle to the normal of the plane of the diffractive optical coupling element, respectively, n_{g} (λ) is the wavelength dependent refractive index of the substrate material, aᵢ(x₂) is the grating spacing. Since θᵢₙ usually is a small angle, the approximation has been made sin θᵢₙ≅θᵢₙ. However, for a person skilled in the art it is straightforward to include the case where this approximation is not valid.

Similarly to eqn.(1), the following analytical expression for the SPR angle can be employed,

$$sin {θ}_{SPR} ≅ {\frac{1}{{n}_{g} ( λ )} [ \frac{{ϵ}_{mr}^{′} ( λ ) {n}_{s}^{2} ( λ )}{{ϵ}_{mr}^{′} ( λ ) + {n}_{s}^{2} ( λ )} ]}^{\frac{1}{2}} \qquad ( 11 )$$

where ε40 ₘᵣ (λ) is the wavelength dependent real part of the dielectric constant of the metal film and nₛ (λ) the wavelength dependent effective refractive index of the sensor element. Equating eqns.(10) and (11), since aᵢ is a monotonous function of x₂, the position x₂ of a light ray with a wavelength λ on the input RDOE being diffracted with a diffraction angle θ₀, equal to θ_{SPR} can be determined from the expression

$${a}_{i} ( {x}_{2} ) = \frac{λ}{\sqrt{\frac{{ϵ}_{mr}^{′} ( λ ) {n}_{s}^{2} ( λ )}{{ϵ}_{mr}^{′} ( λ ) + {n}_{s}^{2} ( λ )}} - {θ}_{i n}} \qquad ( 12 )$$

For a dispersion free detection of a biosensor response, a light ray with a different wavelength λ′ should be diffracted at an angle θ′₀ matching the SPR angle given by eqn.(11) at λ′, and the position x′₂ of the light ray on the input RDOE is determined from eqn.(12) for λ=λ′. Employing ray tracing in FIG. 6 using a rectangular coordinate system (x,z) as illustrated, the positions of a light ray from the light source (xᵢ) to the detector (x₈) is given by the following equations;

$$\begin{matrix}{x}_{i} = {x}_{2} + ( s + \frac{t}{{n}_{g} ( λ )} ) {θ}_{i n} & ( 13 ) \\ {x}_{6} = {x}_{2} - \frac{4 t}{\sqrt{{( \frac{{n}_{g} ( λ ) {a}_{i} ( {x}_{2} )}{λ} )}^{2} - 1}} , & ( 14 ) \\ {x}_{8} ( λ , {x}_{2} ) = {x}_{6} + ( t + {sn}_{g} ( λ ) ) \frac{λ}{{n}_{g} ( λ )} ( \frac{1}{{a}_{o} ( - {x}_{6} )} - \frac{1}{{a}_{i} ( {x}_{2} )} - \frac{{θ}_{i n}}{λ} ) , & ( 15 )\end{matrix}$$

where x₂ is determined from eqn.(12), t is the thickness of the sensor chip, s is the distance from the backside surface of the sensor chip to the surface of the detector array, aᵢ(x₂) is the grating spacing for the input RDOE (21) at the position x₂, and a₀(−x₆) is the grating spacing for the output RDOE (25) at the position x₆.

In eqns.(10-15) the angle of incidence (θᵢₙ) has been assumed to be constant. The present invention also covers cases where this angle varies over the aperture of the input RDOE. A person skilled in the art knows how to make such corrections in order to take this effect into account.

The dispersion compensating grating spacing can be produced using a holographic writing procedure (see FIG. 7) in a photosensitive film spun on a master substrate of glass or the like, and it can be expressed in terms of two pair of coordinates. In polar coordinates (Rₒ₁, αₒ₁) of the focal line of the object wave and (Rᵣ₁, αᵣ₁) of the focal line of the reference wave, the grating spacing for the input RDOE can be written;

$${a}_{i} ( {x}_{2} ) = \frac{{λ}_{r}}{\begin{matrix}\sqrt{( sign ( {R}_{r1} ) \frac{{x}_{2} - {R}_{r1} sin ( {α}_{r1} )}{\sqrt{{( {R}_{r1} cos ( {α}_{r1} ) )}^{2} + {( {x}_{2} - {R}_{r1} sin ( {α}_{r1} ) )}^{2}}} -} \\ {sign ( {R}_{o1} ) \frac{{x}_{2} - {R}_{o1} sin ( {α}_{o1} )}{\sqrt{{( {R}_{o1} cos ( {α}_{o1} ) )}^{2} + {( {x}_{2} - {R}_{o1} sin ( {α}_{o1} ) )}^{2}}} )}^{2}\end{matrix}} \qquad ( 16 )$$

where λ, is the recording wavelength of the holographic writing, and sign(R_{o1,r1})=1 for R_{o1,r1}≧0 and sign(R_{o1,r1})=−1 for R_{o1,r1}<0. In FIG. 7, R_{o1,r1} is positive, when the object/reference wave is converging and negative otherwise; α_{o1,r1} is positive, when an object/reference wave intersecting the origin and projected onto the x-axis is propagating in the positive direction of x and negative otherwise.

An expression similar to eqn.(16) can be written for the grating spacing a₀(−x₆) for the output RDOE with the polar coordinates (Rₒ₂, αₒ₂) of the object wave and (Rᵣ₂, αᵣ₂) of the reference wave. The pair of RDOEs in the sensor chips then provides eight parameters that can be adjusted in order to provide dispersion minimisation.

FIG. 7(a) illustrates schematically the positions of the object wave and the reference wave when writing a first surface relief pattern (27) in a photosensitive film (28) on a master substrate (29) using a first set of polar coordinates (Rₒ₁, αₒ₁) and (Rᵣ₁, αᵣ₁) of the focal line for the object wave (30) and the focal line of the reference wave (31), respectively. The first surface relief pattern defines the input RDOE (21) in FIG. 5. As illustrated in FIG. 7(b), a second surface relief pattern (32) can subsequently be written rotating the master substrate 180° along a rotation axis (33) and using a second set of polar coordinates (Rₒ₂, αₒ₂) and (Rᵣ₂, αᵣ₂) of the focal line for the object wave (34) and the focal line of the reference wave (35) for the output RDOE (25) in FIG. 5, respectively.

The surface relief patterns are transferred into the input and output RDOE for the sensor chip. The task of designing the grating spacing of the input and output RDOE of the preferred embodiment of the present invention involves minimising the following expression in eight variables;

$${min}_{{R}_{o1 ,} {α}_{o1} , {R}_{r1} , {α}_{r1} , {R}_{o2 ,} {α}_{o2} , {R}_{r2} , {α}_{r2}} \{ {\sum }_{{x}_{i} = {x}_{i , min}}^{{x}_{i , max}} {\sum }_{λ = {λ}_{min}}^{{λ}_{max}} {[ {x}_{8} ( λ , {x}_{2} ( λ ) ) - {x}_{8} ( {λ}_{0} , {x}_{2} ( {λ}_{0} ) ) ]}^{2} \} , \qquad ( 17 )$$

where the summation is made numerically over a discrete number of light rays and wavelength, and xᵢ, X₂, and x₈(λ,x₂) are determined from eqns.(12-15).

The SPR response as determined by the detector is given by

$${n}_{s , det} = {[ \frac{{ϵ}_{mr}^{′} ( {λ}_{0} ) {( {n}_{g} ( {λ}_{0} ) sin {θ}_{SPR , det} )}^{2}}{{ϵ}_{mr}^{′} ( {λ}_{0} ) - {( {n}_{g} ( {λ}_{0} ) sin {θ}_{SPR , det} )}^{2}} ]}^{\frac{1}{2}} , \qquad ( 18 )$$

where,

$$tan {θ}_{SPR , det} = \frac{{x}_{6} - {x}_{2}}{4 t}$$

and x₂ and x₆ are determined from eqns.(12),(14) and (15) with x₈ being measured by the detector.

Equation (17) is an alternative expression to eqn.(9) as a formulation of dispersion minimisation. Numerically, eqn.(17) can be solved using standard methods for determination of minima. There are many local minima and one has to select a proper one as a useful solution, with an output beam being quasi-collimated and with the output light beam and the input light beam having similar beam sizes. These requirements are normally fulfilled for a number of solutions, and a solution can be selected which most readily is carried out in the fabrication process.

The numerical problem can further be simplified by restricting the minimisation to four variables using the same coordinates (Rₒ, αₒ, Rᵣ, αᵣ) for the input and the output RDOE. This is the case for the two coordinate sets in FIG. 7, and they have been chosen to be Rₒ₁=Rₒ₂=33.8 mm,αₒ₁=αₒ₂=61.5°;Rᵣ₁=Rᵣ₂=38.0 mm,αᵣ₁=αᵣ₂=3.1°. For the replicated sensor chip with a reconstruction light beam as illustrated in FIG. 5, the ray tracing calculation has been carried out solving eqns.(12-17) using these parameters. Using the same coordinates for the input and the output RDOEs makes the fabrication procedure simpler, since the focal points do not have to be changed between the writing of the input RDOE and the writing of the output RDOE. For the case illustrated in FIG. 7, the input angle of incidence for the reconstruction light beam has been assumed to be zero over the aperture of the input RDOE, i.e. a collimated and perpendicularly incident light beam as illustrated in FIG. 5. The size of the apertures of the RDOEs have been selected to be sufficiently large to provide a desirable range in effective refractive index covering at least part of the biosensor response (see FIG. 4c which illustrates an SPR response) for each value of the effective refractive index within the range. As illustrated in FIG. 7a and FIG. 7b, respectively, the apertures may be different for the input RDOE and the output RDOE. For the replicated sensor chip, the focal point for the input (reconstruction) light beam may be positioned at a distance (36) from the central axis (z). For the case illustrated in FIG. 7, the distance is 0.3 mm with the focal point being shifted towards the output RDOE in the replicated sensor chip (20) (see FIG. 5).

The procedure of producing a sensor chip with dispersion compensating diffractive optical elements is as follows. A plane master substrate of glass or the like (29) is spin coated on a plane first surface with a photosensitive film (28) with a thickness of 0.5−3 μm. The photosensitive film like a negative photoresist is pre-exposed with a UV lamp, typically in a few seconds, in order to achieve a linear regime in the holographic recording process afterwards. The photosensitive film is simultaneously illuminated by two overlapping light waves originating from the same monochromatic and coherent light source forming an interference pattern (27).

A first light wave referred to as the first object wave is a light wave, which is focussed to a first desirable focal point or focal line (30). A second light wave referred to as the first reference wave is a light, which is focussed to a second desirable focal point or focal line (31). A first exposure of the photosensitive film is made overlapping the first object wave and the first reference wave in a suitable exposure time in order to ensure the right depth of the diffractive optical element and optimise the diffraction efficiency.

A third light wave referred to as a second object wave is a light wave, which is focussed to a third desirable focal point or focal line (34). A fourth light wave referred to as the second reference wave is a light wave, which is focussed to a fourth desirable focal point or focal line (35). A second exposure of the photosensitive film is made overlapping the second object waves and reference waves in a suitable exposure time in order to ensure the right depth of the diffraction gratings and optimise the diffraction efficiency.

The photosensitive film is subsequently being developed to create the surface relief patterns (27) and (32) being transferred to form the input reflection diffractive optical element (RDOE) (21) and the output RDOE (25) on a replicated substrate (20) as illustrated in FIG. 5.

The positions of the first and the second object waves and the first and the second reference waves are made in order to yield an RDOE (21) having the desirable property of directing a reconstruction input light beam at a range of angles to a region underneath the sensor element (24) in FIG. 5, a second RDOE (25) having the desirable property of directing said light beam into an output light beam comprising rays with a cone of angles exiting the sensor chip, and ensuring a minimum in dispersion of the detection of the biosensor response.

Between the first exposure and the second exposure of the photosensitive film, the master substrate may be turned 180 degrees around a rotation axis (33) perpendicular to the plane of the master substrate.

FIG. 8 illustrates calculations on the preferred embodiment of the present invention with dispersion minimisation (see FIG. 5) of the spatial width of light rays on a detector array exhibiting a minimum in the SPR response for the wavelength range of λ from λ₀−2.5 nm to λ₀+2.5 nm as function of SPR angle for λ₀=670 nm. The calculation is plotted as a solid curve for the case of a wavelength independent effective refractive index, nₛ(λ)=nₛ₀. Results are also plotted for the case of the prior art prism coupler SPR sensor (see FIG. 1), and the prior art SPR sensor chip with no dispersion minimisation (see FIG. 2). In addition, for the case of the preferred embodiment of the present invention, a calculation including the dispersion of a bio-/chemical sensor element exhibiting the same functional wavelength dependence of the refractive index as water is illustrated as a dashed curve. In this calculation, nₛ(λ) in eqn.(12) has been replaced by,

$${n}_{s} ( λ ) = {n}_{s0} \frac{{n}_{w} ( λ )}{{n}_{w} ( {λ}_{0} )}$$

with n_{w}(λ) being the

wavelength dependent refractive index of water and nₛ₀ being wavelength independent. In order to enable a comparison between a prism-coupler SPR sensor and a SPR sensor chip, the distance chosen to the detectors exhibit the same beam size on the detector array.

In the calculations, as substrate material, the plastic material TOPAS has been assumed with experimental data from

1. www.gsootics.com and

2. www.polycarb.org/educ04.htm

in the calculation of n_{g} (λ). Data of wavelength dependence of refractive index for water has been taken from [Ref. Handbook of Chemistry and Physics, 80ₜₕ edition, David R. Lide ed., CRC Press, Boca Raton, 1999]. The metal film has been assumed to be gold and data of electropolished Au(110) from the same reference have been used in the calculation of ε′ₘᵣ (λ) after multiplying the data by a constant factor in order to yield an SPR angle of 68.8° for water at room temperature as measured experimentally.

It should be noted, however, that the actual material parameters depend on the process conditions for the fabrication of the body of the sensor chip, and the metal film on the sensor chip. As it is known by a person skilled in the art, when designing the dispersion minimised sensor chip, one therefore has to optimise the performance taking material specific parameters and process specific parameters into account.

It is noted from FIG. 8, that whilst the prior art non-dispersion minimised SPR sensor chip and the prior art prism-coupler SPR sensor at the minimum in the SPR response exhibit a spatial width of the light rays on the detector of similar magnitudes, the dispersion minimised SPR sensor chip exhibits a much smaller spatial width. It is also noted that including dispersion of the sensor element on the metal film only changes the result slightly. This shows that the system is not sensitive to variations in the dispersion of the sensor element. It is useful that this contribution is small, since the dispersion of the sensor element is often unknown and it is therefore difficult to make compensation for this element.

FIG. 9 illustrates calculations based on eqn.(18) of (a) assuming a wavelength independent effective refractive index, nₛ(λ)=nₛ₀,the dispersion in a dispersion minimised SPR sensor chip, which is the preferred embodiment of the present invention (see FIG. 5). In (b), a similar calculation is illustrated, but it includes the dispersion of a sensor element exhibiting the same functional dependence of refractive index on wavelength as water, i.e.

$${n}_{s} ( λ ) = {n}_{s0} \frac{{n}_{w} ( λ )}{{n}_{w} ( {λ}_{0} )} .$$

The results are presented at five different SPR angles from 67° to 75° as indicated corresponding to a variation in the effective refractive index approximately from n_{s,min}=1.33 to n_{s,max}=1.37 and for a wavelength distribution of the light of ±2.5 nm at 670 nm. It is observed that for the angle and wavelength ranges depicted, the dispersion in the present embodiment of the invention is about one order of magnitude lower than the prior art prism-coupler SPR system and the prior art non-dispersion compensated sensor chip (compare FIG. 9 with FIG. 3). Comparing FIG. 9(a) and FIG. 9(b), it is observed that including dispersion of the sensor element on the metal film only changes the result slightly.

If the light source has a central wavelength different from the central design wavelength (λ₀), the angle of incidence (θᵢₙ) can be adjusted in order to optimise the minimum dispersion. For a positive angle of incidence, i.e. an input light ray has a negative slope as illustrated in FIG. 6, the dispersion curves in FIG. 9 are moving towards larger negative values. For a negative angle of incidence, the dispersion curves in FIG. 9 are moving towards larger positive values.

The description of the dispersion compensating biosensor has been focussing on the SPR sensor. However, a similar description can be made for other biosensors including resonant mirror sensors and sensors, which are sensitive to wavelength variations. The present invention includes embodiments using dispersion compensation due to wavelength shifts and with biosensor response being based on changes in the optical signals caused by bio-/chemical interactions including deflection angle of light, diffraction angle of light, intensity, phase, polarisation, interference, Raman shift, acousto-optical interaction, and interaction with surface acoustic waves.

1. A biosensor comprising
a transparent sensor chip,
a sensing area for interaction between a provided multitude of light rays with a range of angles of incidence to said sensing area and a substance, the interaction between the provided multitude of light rays and the substance defining at least part of a response of the biosensor, and
a part of the biosensor comprising at least one dispersion compensating element being adapted to, at least substantially independently of the effective refractive index of said substance within a predetermined effective refractive index range, compensate the dispersion induced in the biosensor by other parts of the biosensor,
so as to obtain a response of the biosensor being essentially independent of the wavelength of the multitude of light rays interacting with the substance.

2. A biosensor according to claim 1, said biosensor defining an image plane, wherein the multitude of light rays are imaged onto the image plane in such a way that for any light ray rᵢ belonging to the multitude of light rays having a wavelength λᵢ and angle of incidence θᵢ, said light ray rᵢ exhibiting subpart Rᵢ of the response of the biosensor and being imaged onto the image plane at a position Pᵢ, the dispersion compensating element is adapted to ensure that any light ray rₖ belonging to the multitude of light rays having a wavelength λₖ and an angle of incidence θₖ, said light ray rₖ exhibiting a subpart of a response of the biosensor corresponding to Rᵢ is imaged onto the image plane at essentially the same position Pᵢ.

3. A biosensor according to claim 1, further comprising a detector array.

4. A biosensor according to claim 3, further being adapted to yield minimum dispersion of the response of the biosensor by adjusting the distance between the transparent sensor chip and the detector array.

5. A biosensor according to claim 3, further being adapted to yield minimum dispersion of the response of the biosensor by adjusting an angle between a direction defined by a mean propagation vector of the incoming light rays and a plane defined by the detector array.

6. A biosensor according to claim 1, wherein the response of the biosensor is a surface plasmon resonance response.

7. A biosensor according to claim 1, wherein the transparent sensor chip is solid.

8. A biosensor according to claim 1, wherein the other parts of the biosensor comprise one or more conducting films being arranged on an exterior surface part of the transparent sensor chip, and forming part of the sensing area.

9. A biosensor according to claim 8, wherein the one or more conducting films are arranged in a multilayer system of conducting films.

10. A biosensor according to claim 8, wherein the one or more conducting films comprise metal layers of a material selected from the group consisting of aluminium, gold, silver or the like.

11. A biosensor according to claim 1, wherein the other parts of the biosensor comprise a multilayer of dielectric materials forming a resonant mirror being arranged on an exterior surface part of the transparent sensor chip, and forming part of the sensing area.

12. A biosensor according to claims 1, further comprising
a first and a second diffractive optical element forming part of a surface of the transparent sensor chip, the diffractive optical elements each comprising a grating structure.

13. A biosensor according to claim 12, wherein at least one of the dispersion compensating element(s) forms part of at least one of the diffractive optical elements.

14. A biosensor according to claim 13, wherein the dispersion compensating element(s) forming part of at least one of the diffractive optical elements is further adapted to compensate the dispersion induced by said diffractive optical element.

15. A biosensor according to claim 12, wherein the grating structures form a transmission grating structure.

16. A biosensor according to claim 12, wherein the grating structures form a reflection grating structure.

17. A biosensor according to claim 12, wherein the first diffractive optical element is adapted to focus or diverge an incoming light ray.

18. A biosensor according to claim 12, wherein the second diffractive optical element is adapted to collimate a diverging light ray.

19. A biosensor according to claim 12, wherein the diffractive optical elements further comprises one or more calibration marks, said one or more calibration marks being areas with missing grating structures.

20. A biosensor according to claim 12, wherein the multitude of light rays are incident at least substantially normal to a plane defined by the first diffractive optical element.

21. A biosensor according to claim 1, wherein at least the dispersion compensating element has been provided by performing the following steps:
providing a master substrate having a substantially plane surface,
providing a photosensitive layer of material onto the substantially plane surface of the master substrate,
providing a first surface relief pattern by exposing the photosensitive layer to a first and a second wave of electromagnetic radiation so as to expose the photosensitive layer to a first interference pattern generated by a spatial overlap at an intersection between the first wave of electromagnetic radiation having a first focussed area and the second wave of electromagnetic radiation having a second focussed area,
providing a second surface relief pattern by exposing the photosensitive layer to a third and a fourth wave of electromagnetic radiation so as to expose the photosensitive layer to a second interference pattern generated by a spatial overlap at an intersection between the third wave of electromagnetic radiation having a third focussed area and the fourth wave of electromagnetic radiation having a fourth focussed area,
wherein the positions of the first, second, third, and fourth focussed areas are selected in such a way that the first and second diffractive optical elements replicated from the surface relief patterns compensate for dispersion induced by other parts of the optical sensor.

22. A method of forming surface relief patterns adapted to be replicated onto a substantially plane surface of a member to form a first and a second diffractive optical element, the substantially plane member forming part of an optical sensor, the method comprising the steps of
providing a master substrate having a substantially plane surface,
providing a photosensitive layer of material onto the substantially plane surface of the master substrate,
providing a first surface relief pattern by exposing the photosensitive layer to a first and a second wave of electromagnetic radiation so as to expose the photosensitive layer to a first interference pattern generated by a spatial overlap at an intersection between the first wave of electromagnetic radiation having a first focussed area and the second wave of electromagnetic radiation having a second focussed area,
providing a second surface relief pattern by exposing the photosensitive layer to a third and a fourth wave of electromagnetic radiation so as to expose the photosensitive layer to a second interference pattern generated by a spatial overlap at an intersection between the third wave of electromagnetic radiation having a third focussed area and the fourth wave of electromagnetic radiation having a fourth focussed area,
wherein the positions of the first, second, third, and fourth focussed areas are selected in such a way that the first and second diffractive optical elements replicated from the surface relief patterns compensate, at least substantially independently of the effective refractive index of said substance within a predetermined effective refractive index range, for dispersion induced by other parts of the optical sensor.

23. A method according to claim 22, wherein the master substrate is rotated approximately 180 degrees after the providing of the first surface relief pattern and prior to the providing of the second surface relief pattern.

24. A method according to claim 22, wherein the first, second, third and fourth waves of electromagnetic radiation have substantially the same wavelength.

25. A method according to claim 24, wherein the first, second, third and fourth waves of electromagnetic radiation originate from the same light source.

26. A method according to claim 25, wherein the same light source comprises a laser, such as a HeCd laser, a Kr-laser, an excimer laser, or a semiconductor laser.

27. A method according to claim 22, further comprising the step of developing the photosensitive layer.

28. A method according to claim 22, wherein the first wave of electromagnetic radiation forms an object wave, and wherein the second wave of electromagnetic radiation forms a reference wave.

29. A method according to claim 22, wherein the master substrate is constituted by a substantially transparent member.

30. A method according to claim 29, further comprising the step of performing a sacrificial-layer-etch of the photosensitive layer in order to replicate the first and second surface relief patterns into the substantially plane surface of a substantially transparent member.

31. A method according to claim 30, wherein said step of performing a sacrificial-layer-etch of the photosensitive layer is achieved by means of ion-milling, chemically assisted ion-beam etching or reactive ion etching.

32. A method according to claim 22, further comprising the step of forming a negative metal master of the first and second surface relief patterns for further replication of said first and second surface relief patterns.

33. A method according to claim 32, wherein the metal master is a nickel master.

34. A method according to claim 32, further comprising the step of replicating, in a substantially transparent sensor chip, the first and second surface relief patterns from the negative metal master using hot embossing.

35. A method according to claim 32, further comprising the step of replicating, in a substantially transparent sensor chip, the first and second surface relief patterns from the negative metal master using injection moulding.

36. A method according to claim 32, further comprising the step of replicating, in a substantially transparent sensor chip, the first and second surface relief patterns from the negative metal master using injection compression moulding.

37. A method according to claim 34, further comprising the step of providing a metal layer on top of the replicated first and second surface relief patterns.

38. A method according to claim 37, wherein the metal layer is provided by means of thermal evaporation, e-beam evaporation or sputtering.

39. A method according to claim 37, wherein the provided metal layer comprises a material selected from the group consisting of aluminium, gold, silver or the like.
